(19) United States
(12) Patent Application Publication
(10) Pub. No.: US 2005/0264719 A1
(43) Pub. Date: Dec. 1, 2005

(54) Display device and electronic device utilizing the same

(76) Inventors: Kuang-Tao Sung, Fongyuan City (TW); Liu-Cheng Lin, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/931,638

(22) Filed: Sep. 1, 2004

(30) Foreign Application Priority Data
May 31, 2004 (TW) 93115482

(51) Int. Cl. G02F 1/1333

(52) U.S. Cl. 349/96

(57) ABSTRACT

A display device. The display device includes a front light unit, a color filter, an optical polarizer film, a transmissive and reflective polarizer film, and a transmissive panel. The front light unit comprises a light guide plate and a light source, disposed on an end of the light guide plate. The color filter is disposed on the light guide plate. The optical polarizer film is sandwiched between the front light unit and the color filter. The transmissive panel is sandwiched between the color filter and the transmissive and reflective polarizer film. An electronic device utilizing the display device is also disclosed.

### BACKGROUND OF THE INVENTION

1. Field of the Invention

The present invention relates to a dual display device and an electronic device utilizing the same, and in particular to a dual display device with only one panel, providing equal screen resolution for both sides.

2. Description of the Related Art

Liquid crystal displays (LCDs) are used in a variety of electronic devices, including notebook and desktop computer monitors, mobile phones, PDAs, and TVs. A mobile phone is taken as an example of an electronic device utilizing a dual display panel. FIGS. 1A and 1B are schematic views of a conventional mobile phone 1 in closed and open positions, showing a sub display panel 12 and a main display panel 10, respectively. FIG. 1C is a schematic side view of a backlight unit 16 of the mobile phone 1. In a conventional design, the LCD 2 of the mobile phone 1 comprises a main display panel 10, a sub display panel 12, and a backlight unit 16 with a light source 18, disposed therebetween, enabling simultaneous operations of both sides of the display 2. Thus, information from the mobile phone 1 can be viewed from both sides of the LCD 2. The main display panel 10 is disposed on the inner side of the cover. A smaller display, disposed on the outer side of the cover, the sub display panel 12, providing functions such as displaying a phone number when the cover is closed. The main display panel 10 is a thin film transistor (TFT) or a color super twisted nematic (CSTN) panel. The sub display panel 12 is a TFT, CSTN, a super-twisted nematic (STN), or an organic light emitting diode (OLED) panel. Although both panels 10 and 12 share one backlight unit 16 and system LSI chip (not shown) to minimize internal space, the design requires two single-sided LCD panels 10 and 12. This type of mobile phone design utilizing backlight unit 16 commonly has a thickness of 4.5 mm, such that the dual-screen LCD 2 is still considerably thick.

Furthermore, the main display panel 10 is larger and of a different type. To reduce material cost, the sub display panel 12 is typically an STN, CSTN, or OLED panel, having lower resolution and less brightness than the main display panel 10, which is typically a TFT-LCD panel. The backlight unit 16 is disposed in the LCD 2 in a way that higher percentage of light is directed to the main display panel 10. Namely, the backlight unit 16 does not provide the same brightness level in both directions. Thus, the main display panel 10 has better resolution and higher light intensity than the sub display panel 12.

Obviously, either size or brightness of the conventional LCD with dual display panels is limited by the arrangement of the light source and types of panels. Thus, there is a need for a dual display LCD capable of providing equal brightness and resolution in both display directions by specific arrangement of the optical films.

### SUMMARY OF THE INVENTION

Thus, an object of the invention is to provide a LCD with a dual display function with better brightness and equal resolution quality in both display directions.

Another object of the invention is to provide a dual display device and an electronic device utilizing the same, eliminating one panel, thus making the electronic device as slim as possible.

The present invention provides a display device comprising a front light unit, a color filter, an optical polarizer film, a transmissive and reflective polarizer film, and a transmissive panel. The front light unit comprises a light guide plate and a light source, disposed on an end of the light guide plate. The color filter is disposed along the light guide plate. The optical polarizer film is sandwiched between the front light unit and the color filter. The transmissive panel is sandwiched between the color filter and the transmissive and reflective polarizer film.

The display device further comprises an optical adhesive layer disposed between the front light guide and the color filter.

In a first embodiment, the optical polarizer film comprises an anti-reflective film.

In a second embodiment, the optical polarizer film comprises an anti-glare film.

In a third embodiment, the optical polarizer film comprises a combination of an anti-glare film and an anti-reflective film.

The transmissive panel is a thin film transistor panel.

The invention also provides a display device comprising a front light unit, an optical polarizer film, a transmissive panel, a transmissive and reflective polarizer film, and a color filer. The front light unit comprises a light guide plate and a light source, disposed on an end of the light guide plate. The transmissive panel is disposed along the light guide plate. The optical polarizer film is sandwiched between the transmissive panel and the light guide plate. The color filter is sandwiched between the transmissive panel and the transmissive and reflective polarizer film.

The display device further comprises an optical adhesive layer disposed between the front light guide and the transmissive panel.

In one embodiment, the optical polarizer film comprises an anti-reflective film.

In another embodiment, the optical polarizer film comprises an anti-glare film.

In another embodiment, the optical polarizer film comprises a combination of an anti-glare film and an anti-reflective film.

The transmissive panel is a thin film transistor panel.

An electronic device utilizing the LCD with dual display is also disclosed.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic perspective view of a conventional mobile phone with a sub display panel in a closed position;

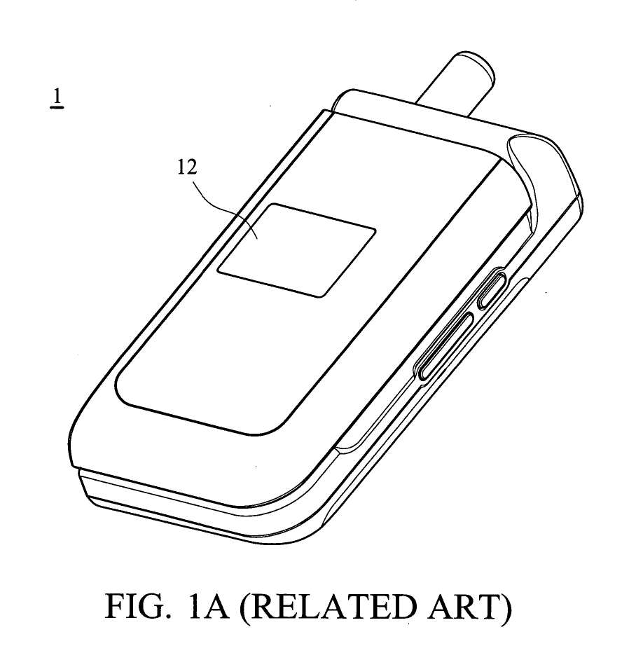

FIG. 1B is a schematic perspective view of the conventional mobile phone with a main display panel in an open position;

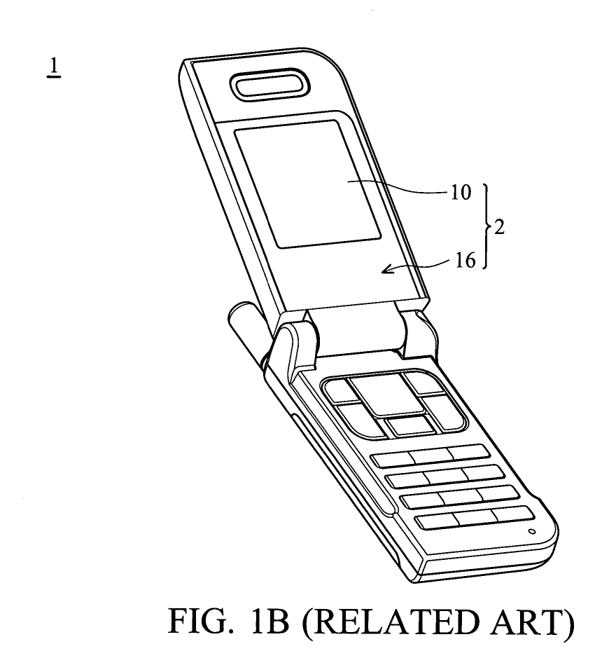

FIG. 1C is a schematic cross section of a backlight unit of the conventional mobile phone;

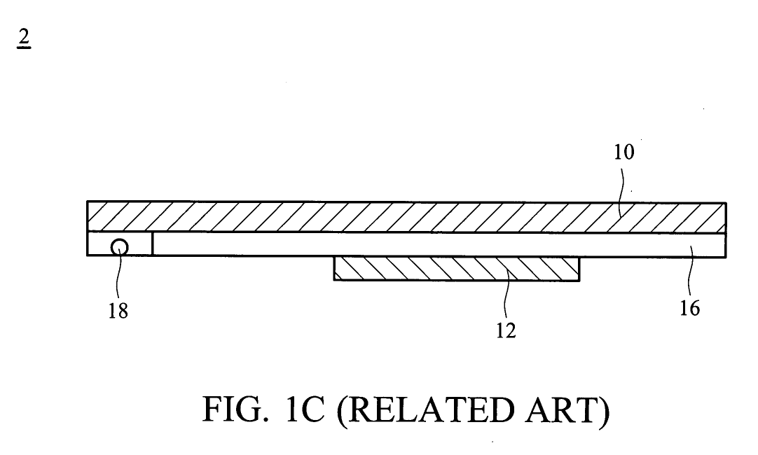

FIG. 2A is a schematic perspective view of a mobile phone with a dual display LCD according to the present invention;

FIG. 2B is a cross section of a liquid crystal display of the mobile phone according to the first embodiment of the present invention;

FIG. 2C is a cross section of a liquid crystal display according to a variation of the first embodiment;

FIG. 2D is a cross section of a liquid crystal display according to another variation of the first embodiment;

FIG. 3A is a cross section of a liquid crystal display according to the second embodiment of the present invention;

FIG. 3B is a cross section of a liquid crystal display according to a variation of the second embodiment; and

FIG. 3C is a cross section of a liquid crystal display according to another variation of the second embodiment.

### DETAILED DESCRIPTION OF THE INVENTION

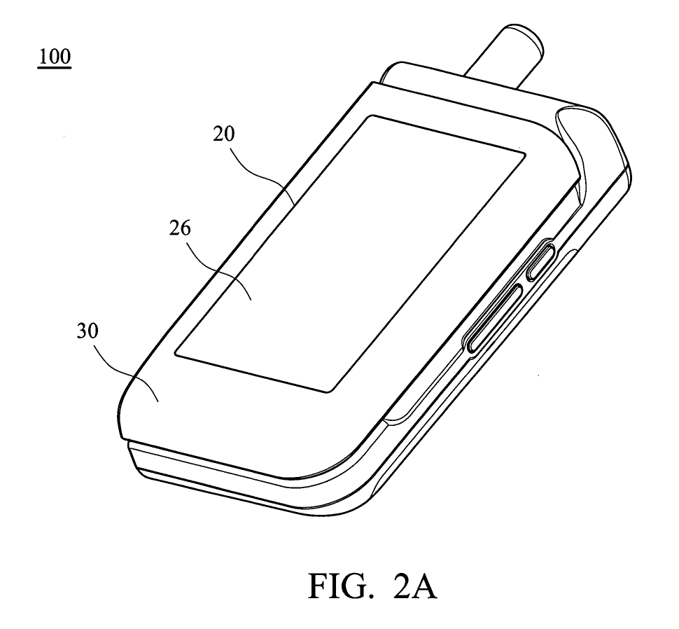

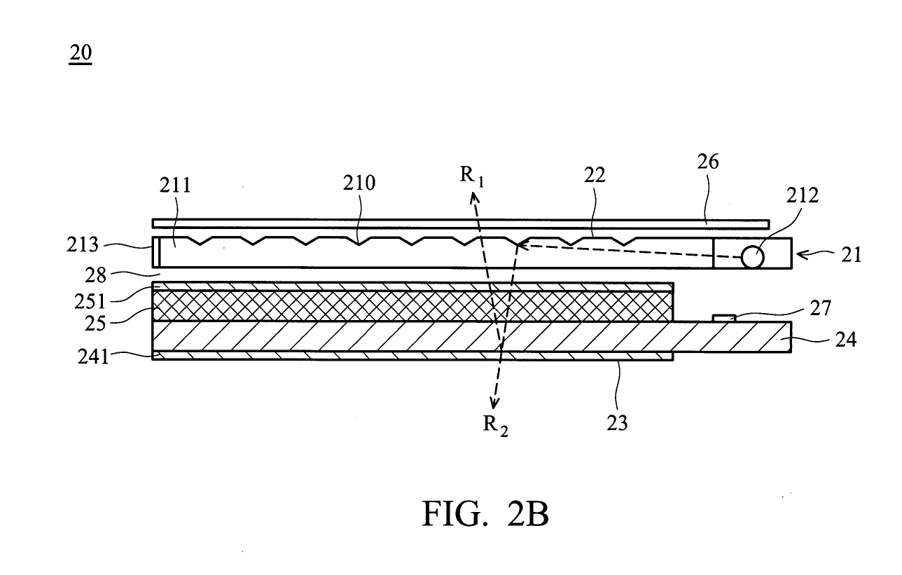

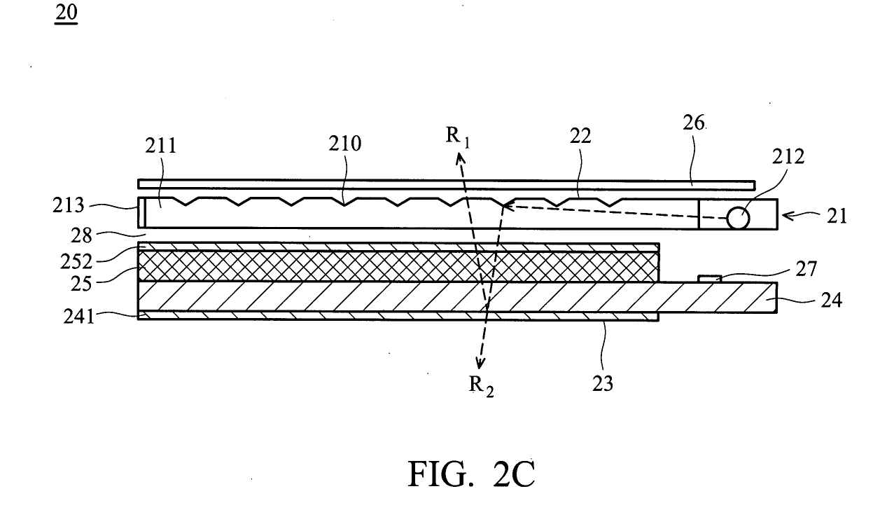

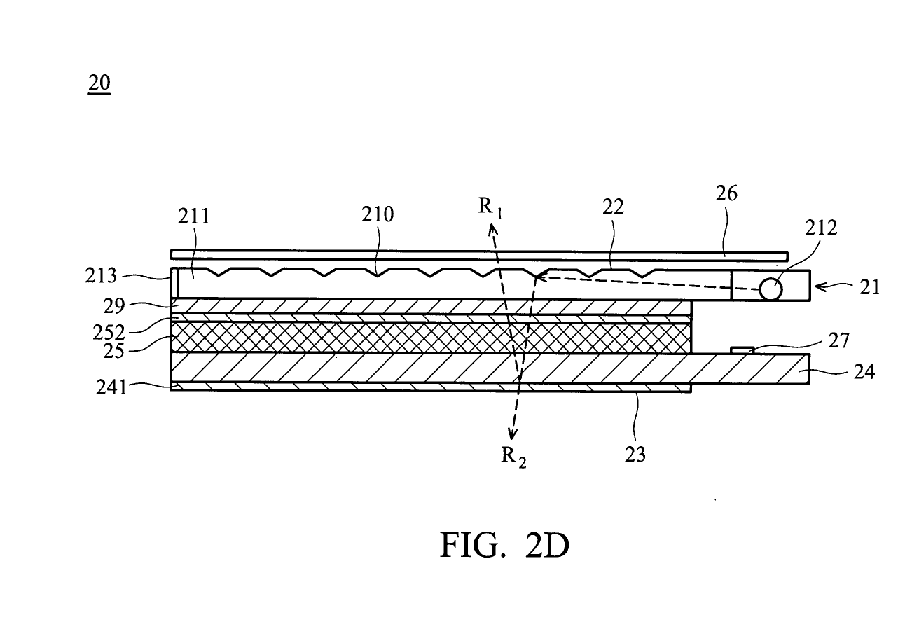

FIG. 2A is a schematic perspective view of a mobile phone 100 according to the present invention. The mobile phone 100 has a shell-shaped design comprising a display device 20, a transparent cover 26, and a housing 30. The transparent cover 26 protects the LCD 20 disposed in the housing 30. A detailed description of the LCD with dual display with different film arrangements is provided in the following.

### First Embodiment

FIG. 2B is a cross section of a liquid crystal display 20 of the mobile phone 100 according to the first embodiment of the present invention. As shown in FIGS. 2A and 2B, the viewable screen of the liquid crystal display when the cover of the mobile phone 100 is closed is referred to as the first display side 22. The liquid crystal display 20 comprises a front light unit 21, a color filter 25, and a transmissive TFT panel 24. The color filter 25 is disposed under the front light unit 21 and above the TFT panel 24 with a gap 28 between the front light unit 21 and the color filter 25. The gap 28 having a thickness of about 0.1 mm provides clearance for preventing direct contact to the color filter 25. The transmissive TFT panel 24 has a second display side 23. An integrated circuit (IC) chip 27 is disposed on the TFT panel 24.

The front light unit 21 comprises a lamp 212, a light guide plate 211, a plurality of prism grooves 210, and a reflector 213. The lamp 212 disposed on one end of the light guide plate 211 is one possible light source for the LCD 20. Other potential light sources are a light emitting diode (LED) or ambient light. The prism grooves 210 are formed on the light guide plate 211 for reflecting light from the lamp 212. The reflector 213 disposed at the opposite end of the front light plate 21 further reflects residual light from the lamp 212, enhancing the brightness of the LCD 20.

An anti-reflective function optical polarizer film 251, also known as anti-reflective film 251 (or an optical polarizer film 251 with anti-reflective coating), is adhered to the color filter 25. The anti-reflective film 251 interferes with light rays entering therethrough to greatly reduce reflectance over the range of visible light. Thus, light rays from the light guide plate 211 can pass through the anti-reflective film 251 directly to the color filter 25.

A transmissive and reflective polarizer film 241 is adhered to a side of the transmissive TFT panel 24, opposite to the color filter 25. Namely, the color filter 25 is sandwiched between the anti-reflective film 251 and the TFT panel 24. The transmissive and reflective polarizer film 241, for example, Dual Brightness Enhancement Film (DBEF) (trade name) available from Minnesota Mining and Manufacturing (3M) Company, Inc., is capable of double refraction. Furthermore, the transmissive and reflective polarizer film 241 also provides mirror effect. Thus, when the light reaches the transmissive and reflective polarizer film 241, the incident light can be separated into reflected light and transmitted light of different polarization. The percentage of light reflected by the film 241 toward the first display side 22 is approximately 0.6% of the total incident light, which is significantly effective if the total amount of reflection from each prism groove 210 and the reflector 213 of the front light unit 21 is considered. Thus, the brightness and resolution displayed by the first and second display sides 22 and 23 is substantially equal.

The light path is described in the following. Light emitted by the lamp 212 is transmitted along the light guide plate 211. The light is then reflected by the prism grooves 210 toward the color filter 25 and transmitted through the anti-reflective film 251, the color filter 25, and the TFT panel 24, respectively. When the light reaches the transmissive and reflective polarizer film 241, the light is separated into a reflected light ray R₁ and a transmitted light ray R₂. The reflected light ray R₁ is reflected to the light guide plate 211 and the transmitted light ray R₂ passes through the transmissive and reflective polarizer film 241. Thus, the brightness from both display sides 22 and 23 is enhanced due to the additional reflected light.

The present invention eliminates the use of sub display, different from the main display, such as STN, CST, or OLED. Although the electronic device does not have two LCD panels, the LCD of the invention provides dual display function with equivalent screen resolution and brightness in both directions. Furthermore, the present invention also provides a slimmer design due to eliminating one panel, resulting in an average reduction in thickness of about 38 percent. Thus, the thickness of the mobile phone 100 is reduced to approximately 2.8 mm. The overall weight thereof is reduced and less expensive to manufacture.

FIG. 2C is a cross section of a liquid crystal display according to a variation of the first embodiment. Similar to the first embodiment, the display device 20 comprises a front light unit 21, a color filter 25, and a transmissive TFT panel 24. The description of the variation and symbols used are identical to those of the first embodiment, and thus explanation is omitted herein. The difference between the first embodiment and the variation is the type of optical polarizer film adhered to the color filter 25. In the variation, the optical polarizer film is replaced by an anti-reflective (AR) and anti-glare (AG) film 252. Namely, the optical polarizer film 252 provides both anti-reflective and anti-glare features. Thus, the optical polarizer film 252 can be provided alone with an anti-reflective film or in combination of anti-reflective and anti-glare to further improve the overall performance of the display. The anti-reflective and anti-glare film reduces glare, prevent Mura defects, improves displayed image quality, and improves contrast. The optical polarizer film 252 can improve transmission by eliminating interfaces between materials with different optical properties. Thus, the anti-reflective and anti-glare film 252 has a transmittance up to 92%.

FIG. 2D is a cross section of a liquid crystal display according to another variation of the present invention. Similar to the first embodiment, the display device 20 comprises a front light unit 21, a color filter 25, and a transmissive TFT panel 24. The structure and arrangement of the above components are the same, thus further explanation is omitted. The difference between this variation and the first embodiment is the type of optical polarizer film adhered to the color filter 25. Additionally, the gap 28 is eliminated but filled with an optical adhesive layer 29. In this variation, the optical polarizer film is replaced by an anti-reflective (AR) and anti-glare (AG) film 252. Thus, the optical polarizer film 252 can be provided with only an anti-reflective film or a combination of anti-reflective and anti-glare films to further improve the overall performance of the display by reducing glare, preventing Mura defects, improving displayed image quality, and improving contrast.

The optical adhesive layer 29 is adhered to the film 252 of the color filter 25 and the front light unit 21, thus, eliminating the gap therebetween. The optical adhesive layer 29 also improves contrast. Additionally, the optical adhesive layer 29 allows transmission of light therethrough. Thus, the variation can improve the brightness and resolution in both display directions without increasing total thickness.

### Second Embodiment

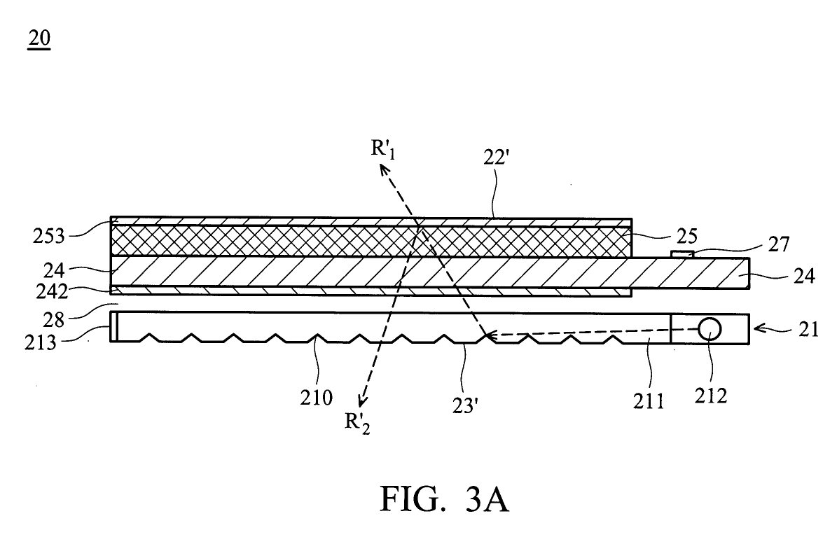

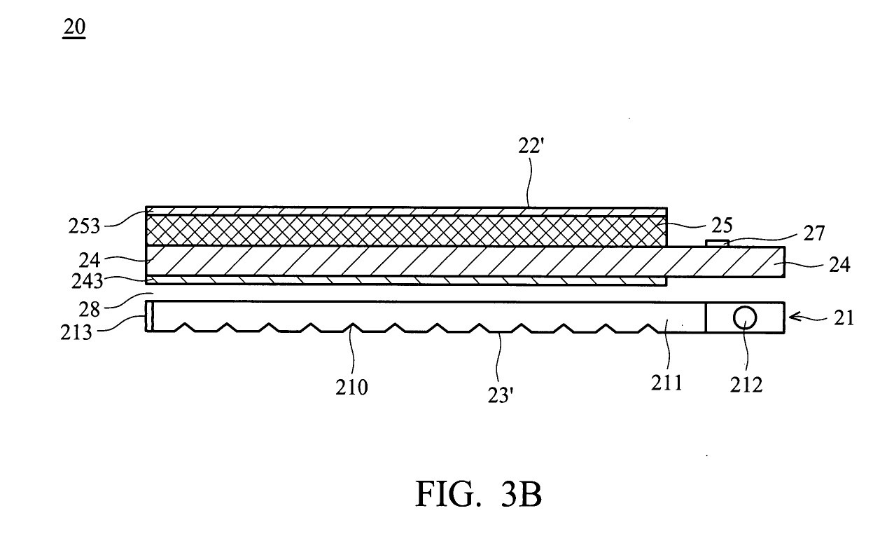

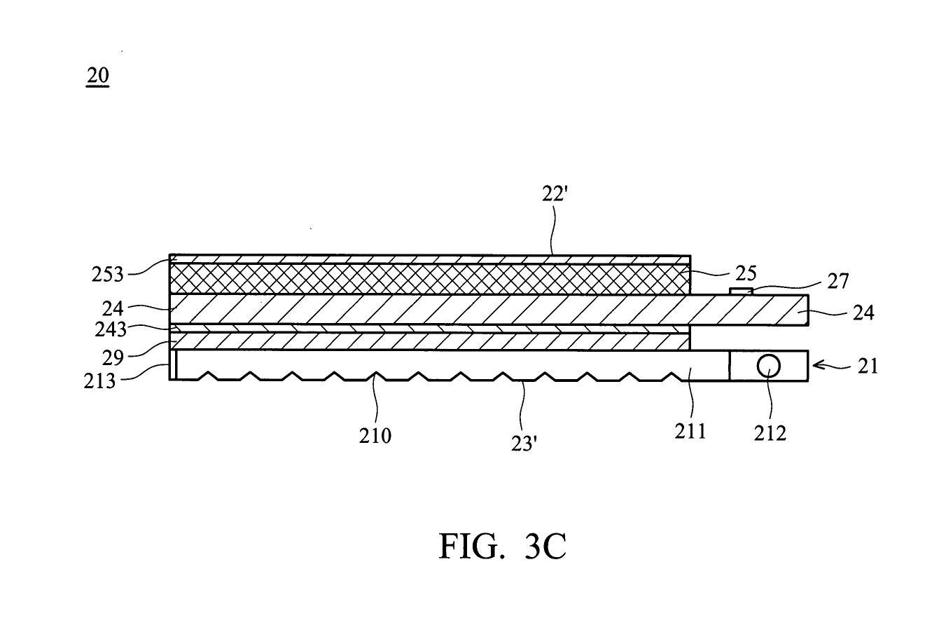

FIG. 3A is a cross section of a liquid crystal display 20 according to the second embodiment of the present invention. The second embodiment has different layer arrangements compared to the first. As shown in FIGS. 3A, the liquid crystal display 20 comprises a first display side 22′, a color filter 25, a transmissive TFT panel 24, a front light unit 21, and a second display side 23′. The transmissive TFT panel 24 is disposed under the color filter 25 and above the front light guide 21 with a gap 28 between the front light unit 21 and the TFT panel 24. The gap 28 is a clearance of about 0.1 mm, preventing direct contact therebetween. The first display side 22′ is disposed above the color filter 25. The second display side 23′, disposed on the underside thereof, comprises a plurality of prism grooves 210 on the light guide plate 211. An integrated circuit (IC) chip 27 is disposed on the TFT panel 24.

The front light unit 21 comprises a lamp 212, a light guide plate 211, the prism grooves 210, and a reflector 213. The lamp 212 disposed on one end of the light guide plate 211 is one possible light source for the LCD 20. A light emitting diode (LED) can also serve as a light source. The prism grooves 210 are formed on the light guide plate 211 for reflecting light from the lamp 212. The reflector 213 disposed at the opposite end of the front light plate 21 further reflects residual light from the lamp 212, enhancing the brightness of the LCD 20.

The transmissive panel 24 and an optical polarizer film 242 are disposed along the light guide plate 211. The optical polarizer film 242 is disposed on the transmissive panel 24 and sandwiched between the transmissive panel 24 and the light guide plate 211 with the gap 28 between the front light unit 21 and the optical polarizer film 242. The optical polarizer film 242 has an anti-reflective property and is referred to anti-reflective film 242. The anti-reflective film 251 interferes with light rays entering therethrough to greatly reduce reflectance over the range of visible light. Thus, light rays from the light guide plate 211 pass through the anti-reflective film 242 directly to the TFT panel 24 and the color film 25.

A transmissive and reflective polarizer film 253 is adhered to the color filter 25. The color filter 25 is sandwiched between the transmissive and reflective polarizer film 253 and the TFT panel 24. The transmissive and reflective polarizer film 253, for example, Dual Brightness Enhancement Film (DBEF) (trade name) available from Minnesota Mining and Manufacturing (3M) Company, Inc., is capable of double refraction. Furthermore, the transmissive and reflective polarizer film 253 also provides mirror effect. Thus, when the light reaches the transmissive and reflective polarizer film 253, the incident light can be separated into reflected light and transmitted light of different polarization. The percentage of light reflected by the film 253 toward the second display side 23′ is approximately 0.6% of the total incident light, which is significantly effective if the total amount of reflection from each prism groove 210 and the reflector 213 of the front light unit 21 is considered. Thus, the brightness and resolution displayed from the first and the second display sides 22′ and 23′ are substantially equal.

The light path is described in the following. Light emitted by the lamp 212 is transmitted along the light guide plate 211. The light is then reflected by the prism grooves 210 toward the optical polarizer film 242 and transmitted through the optical polarizer film (anti-reflective film) 242, the TFT panel 24, the color filter 25, and the transmissive and reflective polarizer film 253, respectively. When the light reaches the transmissive and reflective polarizer film 253, the light is separated into a transmitted light ray R₁′ and a reflected light ray R₂′. The transmitted light ray R₁′ passes through the transmissive and reflective polarizer film 253 toward the first display side 22′ and the light ray R₂′ is reflected to the light guide plate 211 and passes through the second display side 23′. Thus, the brightness from both display sides 22′ and 23′ is enhanced due to the additional reflected light.

The present invention eliminates the use of sub display, different from the main display, such as STN, CST, or OLED. Although the electronic device does not have two LCD panels, the LCD of the invention provides dual display function with equivalent screen resolution and brightness in both directions. Furthermore, the present invention also provides a slimmer design due to eliminating one panel, resulting in an average reduction in thickness of about 38 percent. Thus, the thickness of the mobile phone 100 is reduced to approximately 2.8 mm. The overall weight thereof is reduced and less expensive to manufacture.

FIG. 3B is a cross section of a liquid crystal display according to a variation of the second embodiment. Similar to the second embodiment, the display device 20 comprises a front light unit 21, a color filter 25, and a transmissive TFT panel 24. The description and symbols used are identical to those of the second embodiment, and thus explanation is omitted herein. The difference between the second embodiment and the variations is the type of optical polarizer film adhered to the TFT panel 24. In the variation, the optical polarizer film 242 is replaced by an anti-reflective (AR) and anti-glare (AG) film 243. Namely, the optical polarizer film 243 of the variation provides both anti-reflective and anti-glare features. Thus, the optical polarizer film 243 can be provided alone with an anti-reflective film or in combination of anti-reflective and anti-glare to further improve the overall performance of the display because the anti-reflective and anti-glare film reduces glare, prevent mura defects, improves displayed image quality, and improves contrast and the film 243 can improve transmission by eliminating interfaces between materials with different optical properties. Thus, the anti-reflective and anti-glare film 243 has a transmittance up to 92%.

FIG. 3C is a cross section of a liquid crystal display according to another variation of the second embodiment. Similar to the second embodiment, the display device 20 comprises a front light unit 21, a color filter 25, and a transmissive TFT panel 24. The structure and arrangement of the above components are the same, thus further explanation is omitted herein. The difference between this variation and the second embodiment is the type of optical polarizer film adhered to the TFT panel 24. Additionally, the gap 28 is eliminated and filled with an optical adhesive layer 29. In this variation, the optical polarizer film is replaced by an anti-reflective (AR) and anti-glare (AG) film 243. Thus, the optical polatizer film 243 can be provided with only an anti-reflective film or a combination of anti-reflective and anti-glare films to further improve the overall performance of the display by reducing glare, preventing Mura defects, improving displayed image quality, and improving contrast.

The optical adhesive layer 29 is adhered between the film 243 and the front light unit 21, thus, eliminating the gap 28 therebetween. The optical adhesive layer 29 also improves contrast. Additionally, the optical adhesive layer 29 allows transmission of light therethrough. Thus, the variation can improve the brightness and resolution in both display directions without increasing total thickness.

Hence, the present invention generates high light intensity in either direction, thus producing high quality image display on both sides of the LCD with dual display function and offers a slimmer profile and lighter weight.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A dual display device, comprising:
a front light unit comprising a light guide plate and a light source, disposed on an end of the light guide plate;
a color filter disposed on the light guide plate;
an optical polarizer film, sandwiched between the front light unit and the color filter;
a transmissive and reflective polarizer film; and
a transmissive panel sandwiched between the color filter and the transmissive and reflective polarizer film.

2. The dual display device as claimed in claim 1, further comprising an optical adhesive layer disposed between the front light guide and the color filter.

3. The dual display device as claimed in claim 1, wherein the optical polarizer film comprises an anti-reflective film.

4. The dual display device in claim 1, wherein the optical polarizer film comprises an anti-glare film.

5. The dual display device as claimed in claim 1, wherein the optical polarizer film comprises a combination of an anti-glare film and an anti-reflective film.

6. The dual display device as claimed in claim 1, wherein the transmissive panel is a thin film transistor panel.

7. A dual display device, comprising:
a front light unit comprising a light guide plate and a light source, disposed on an end of the light guide plate;
a transmissive panel disposed on the light guide plate;
an optical polarizer film sandwiched between the transmissive panel and the light guide plate;
a transmissive and reflective polarizer film; and
a color filter sandwiched between the transmissive panel and the transmissive and reflective polarizer film.

8. The dual display device as claimed in claim 7, further comprising an optical adhesive layer disposed between the front light guide and the transmissive panel.

9. The dual display device as claimed in claim 7, wherein the optical polarizer film comprises an anti-reflective film.

10. The dual display device in claim 7, wherein the optical polarizer film comprises an anti-glare film.

11. The dual display device as claimed in claim 7, wherein the optical polarizer film comprises a combination of an anti-glare film and an anti-reflective film.

12. The dual display device as claimed in claim 7, wherein the transmissive panel is a thin film transistor panel.

13. An electronic device utilizing a display device for displaying in two directions, comprising:
a front light unit comprising a light guide plate and a light source, disposed at an end of the light guide plate;
a color filter disposed on the light guide plate;
an optical polarizer film, sandwiched between the front light unit and the color filter;
a transmissive and reflective polarizer film; and
a transmissive panel sandwiched between the color filter and the transmissive and reflective polarizer film.

14. The electronic device as claimed in claim 13, further comprising an optical adhesive layer disposed between the front light guide and the color filter.

15. The electronic device as claimed in Claim 13, wherein the optical polarizer film comprises an anti-reflective film.

16. The electronic device in claim 13, wherein the optical polarizer film comprises an anti-glare film.

17. The electronic device as claimed in claim 13, wherein the optical polarizer film comprises a combination of an anti-glare film and an anti-reflective film.

18. The electronic device as claimed in claim 13, wherein the transmissive panel is a thin film transistor panel.

19. The electronic device as claimed in claim 13, wherein the transmissive and reflective polarizer film is a DBEF film.
